(19) United States
(12) Patent Application Publication
(10) Pub. No.: US 2010/0057573 A1
(43) Pub. Date: Mar. 4, 2010

(54) Systems and methods for an electronic coupon system

(76) Inventor: Tara Chand Singhal, Torrance, CA (US)

Correspondence Address: TARA CHAND SINGHAL, P O BOX 5075, Torrance, CA, 90510, US

(21) Appl. No.: 12/231,618

(22) Filed: Sep. 4, 2008

(51) Int. Cl. G06Q 30/00

(52) U.S. Cl. 705/14.64

(57) ABSTRACT

A coupon delivery and redemption system provides, (i) for wireless delivery of a product coupon file with the coupons of the product merchants to customers' wireless mobile devices from a coupon system anywhere, at home or in store while shopping, (ii) for customer to search and select for display a product coupon from the coupon file, (iii) for coupon redemptions by retail merchants by scanning the coupon bar code from the wireless device screen, (iv) for validation of the coupon for one time use by interfacing of the retail merchant system with the coupon system, (iv) for the product merchant to receive coupon redemption data from the coupon system, and (v) for the retail merchant to receive aggregate funds for redeemed coupons via the coupon system for an efficient and convenient paperless coupon system.

### FIELD OF THE INVENTION

The preferred embodiment is on systems and methods for an electronic coupon system that (i) enables electronic coupons to be received on a mobile wireless phone from a coupon system server, (ii) presented to retail merchants via scan of the coupon bar code on the mobile phone screen, and (iii) processed electronically between the retail merchants and the product merchants via the coupon system server.

### BACKGROUND

Coupons form an important form of advertising in the economy to influence the customer to purchase products. The product merchants plan coupon based advertising campaigns by printing coupons and by delivering such coupons to customers by various means, such as, mail, and print media.

To be able to use such coupons, the consumer or customer clips and takes the coupons to the retail merchants that stock the products. The retail merchant accepts the coupon based on redemption limitations identified on the coupon for the specific products identified on the coupon and the retail merchant charges a discounted price for the products based on the coupon amount. The retail merchants then process these coupons and collect the coupon funds along with a coupon processing administrative fee by submitting the paper coupons to the respective product merchants.

It is an objective of the preferred embodiment to provide for a more efficient paperless coupon collection and redemption system for the consumers.

It is yet another objective of the preferred embodiment to provide for a more convenient, versatile and automated coupon delivery and redemption system for the product merchants.

It is yet another objective of the preferred embodiment to provide for a more efficient and convenient paperless redemption system for the retail merchants.

### SUMMARY

An electronic coupon system for delivery of product coupons of product merchants to customers and redemption by retail merchant system is described.

The coupon system has a coupon system server with interface to a wireless mobile device of the customer. On customer request from anywhere, such as at home or while shopping, the coupon system sends customized coupon files to wireless mobile receivers of customers, when the mobile device is identified by a wireless mobile identifier. The customer may select from categories of coupons in the coupon system based on shopping categories.

The wireless device has a coupon function that receives and locally stores in the device a coupon file with a plurality of merchant coupons. Each coupon may be formatted with fields of, a product merchant id, a coupon amount, an expiration date, a product's identification, redemption limitations, and a coupon bar code. The coupon function in the wireless device enables the customer to search and select a product coupon from the coupon file and display the selected coupon on the mobile wireless device screen, enabling the coupon bar code to be scanned by a retail merchant scanner.

After scanning the coupon bar code, the retail merchant system interfaces with the coupon system in real time for validating the coupon code and preventing a coupon code from being used twice from the wireless device.

The coupon system tracks the coupons that have been used by wireless device identifier and may prevent the coupon system from sending the same coupons to the same wireless mobile device in a time period.

The coupon system also tracks the coupons that have been redeemed and provides accounting to the product merchant system via the product merchant interface to the coupon system. The coupon system has an interface with product merchants for account management and entering coupons data, receiving coupon redemption data, and transferring coupon redemption funds from the product merchant system to the retail merchant system.

The product merchant interface to the coupon system is facilitated via a web interface that enables (i) planning a coupon based advertising campaign, (ii) creating and entering product coupons, each coupon identified by fields of, product id, coupon amount, redemption limitations, and coupon expiration date into the coupon system. Also the product merchant interface provides a web interface that enables receiving coupon redemption data and paying for the coupons, that have been redeemed, to the retail merchant.

### BRIEF DESCRIPTION OF THE DRAWINGS

Some of the novel features of this invention will be best understood from the accompanying drawings, taken in conjunction with the accompanying description, in which similar reference characters refer to similar parts, and in which:

FIG. 1 is a block diagram that illustrates features of the present invention of electronic coupon system.

FIG. 2 is a block diagram that illustrates features of the present invention of coupon function in the wireless device.

FIG. 3A is a block diagram that illustrates features of the present invention of coupon function in the wireless device.

FIG. 3B is a block diagram that illustrates features of the present invention of coupon system function in the coupon server.

FIG. 4 is a block diagram that illustrates features of the databases of the present invention of electronic coupon system.

FIG. 5 is a block diagram that illustrates features of the web interface of Product Merchant to Coupon system.

FIG. 6 is a method diagram that illustrates features of the present invention of electronic coupon system.

### DESCRIPTION

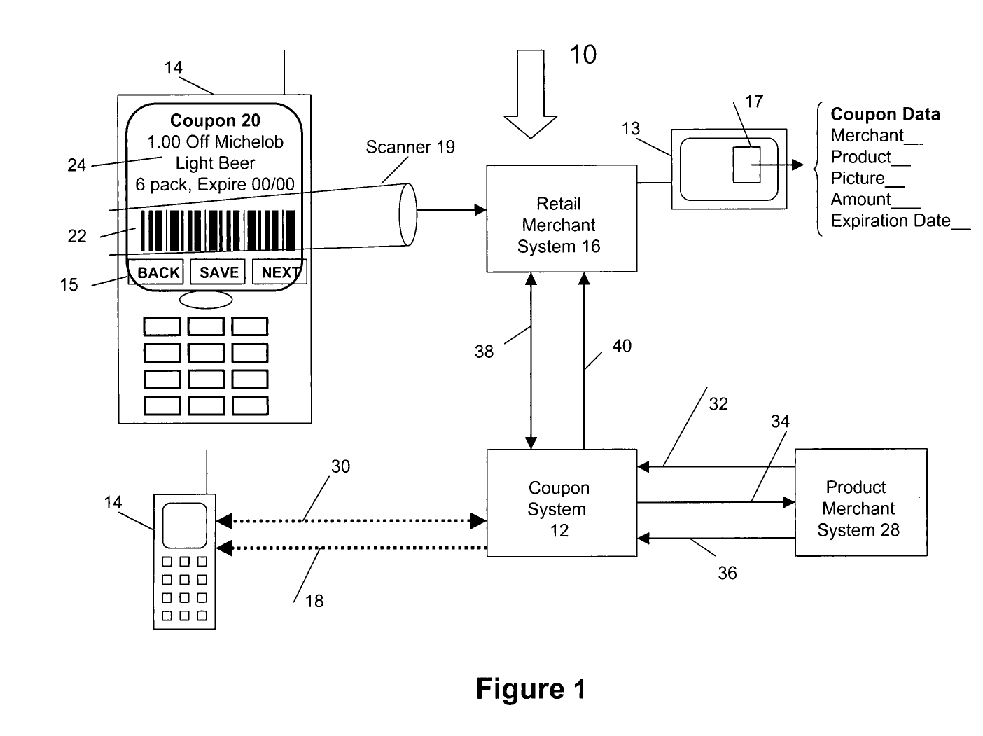

With reference to FIG. 1, an electronic coupon system 10 for delivery of product coupons 20 of product merchants 28 to customers with wireless devices 14 and redemption by retail merchant system 16 is facilitated by a coupon system 12.

The coupon system is able to send customized coupon files 18 to wireless mobile receivers 14 of customer, on customer request 30 when the mobile device is identified by a wireless device identifier to the coupon system 12.

The wireless device 14 is able to scroll 15 the coupon file 18 displaying coupons 20 in the device 14. The coupon 20 on the wireless device 14 is selected and displayed with product description and redemption limitations 24 and a coupon bar code 22. The product description 24 may also include a product picture. The coupon bar code 22 is scanned by a retail merchant scanner 19 that is interfaced to the retail merchant system 16.

The retail merchant system 16 has an interface 38 with the coupon system 12 for validating the coupon code 22 in real time and preventing a coupon code from being used twice from the same wireless device 14. The retail merchant system 16 has a display terminal 13 that may display a coupon window 17 identifying the coupon data that is received from the coupon system 12.

The coupon system 12 has an interface 32 with the product merchant system 28 for account management and receiving coupon data, an interface 34 for sending coupon redemption data to the product merchant 28, an interface 36 for receiving coupon redemption funds from the product merchant system 28, and an interface 40 for transferring the coupon redemption funds to the retail merchant system 16.

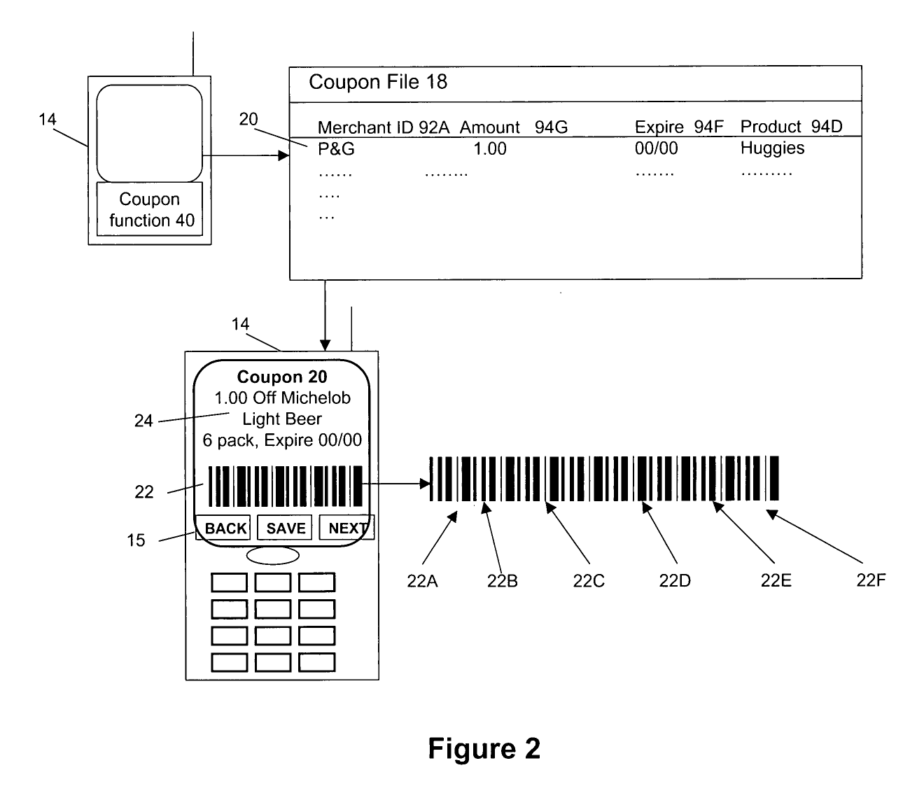

The coupon system 12 tracks the coupons that have been redeemed by the retail merchant 16 when the retail merchant validates the coupon bar code 22 with the coupon system 12 via interface 38. The coupon system 12 provides a periodic or on demand accounting to the product merchant system 28 of the redeemed coupons via the product merchant interface 34. The coupon system 12 tracks the coupons that have been used by wireless device identifier 22A, as illustrated in FIG. 2 and prevents the coupon system 12 from sending the same coupons to the same device 14 owner in a time period.

The scannable coupon code 22 may embed sub-codes for, mobile device id, merchant id, amount, expire date, product id, and serial number. The bar code enables the retail merchant to process the coupon by the coupon code with the coupon system 12.

An interface 38 between retail merchant system and the coupon server 12 validates the coupon code in real time and prevents a coupon code from the wireless device from being used twice.

The coupon server 12 tracks the coupons that have been used by device subscriber 22A and the server does not send the same coupons to the device owner 14 in a time period.

With reference to FIG. 2, the wireless device 14 has been adapted with a coupon function 40 that receives and locally stores in the device 14 a coupon file 18 with a plurality of merchant coupons 20. Each coupon file may be formatted with fields of, a product merchant id 92A, a coupon amount 94G, an expiration date 94F, a product identification 94D, and a coupon bar code 22. There may be additional fields not specified herein. The coupon function 40 enables the customer to search and select, via scroll function 15, the coupon file 18 and display the selected coupon 20 on the device screen with product description 24, and coupon bar code 22, enabling the coupon bar code 22 to be scanned by a retail merchant scanner.

The coupon bar code 22 may embed sub-codes for, a wireless device identifier 22A, product category or class 22B, the product merchant id 22C, the coupon id 22D, the coupon amount 22F, and the coupon expire date 22E, enabling the retail merchant system 16 to process the coupon 20 by the coupon bar code 22. The wireless device identifier 22A may be the telephone number that is assigned by the telephone company.

Mobile devices 14 have screens that are large enough to display such a coupon bar code. Alternatively, the coupon bar code may be a serial number that matches with the coupon id and the related coupon data in the coupon system 12.

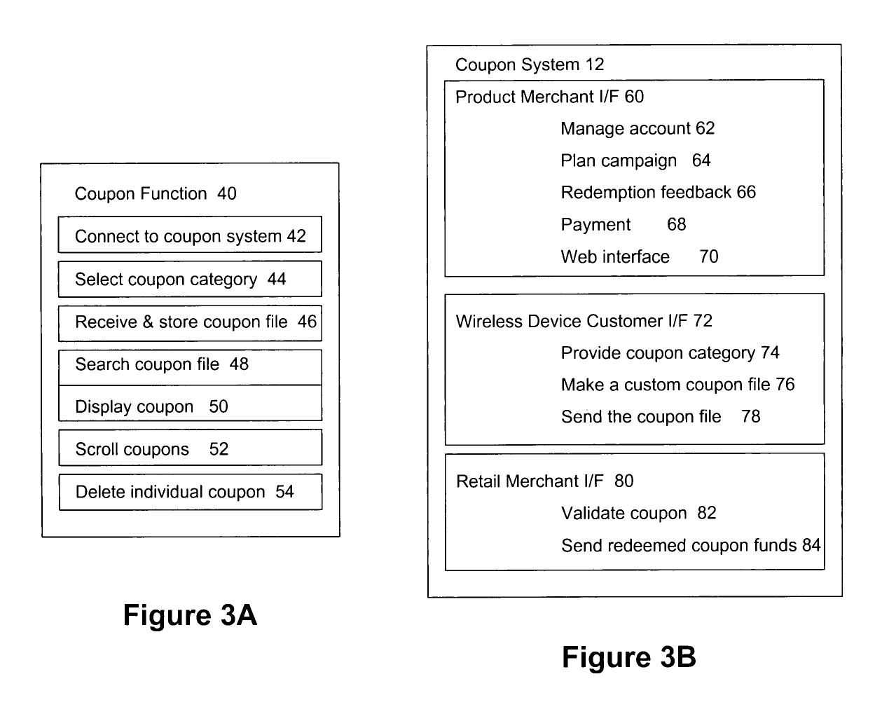

With respect to FIG. 3A, the coupon function 40 in the mobile wireless device 14 has means to connect to the coupon system 42; means to select coupon category 44 from a list of such categories; means to receive and locally store 46 in the mobile wireless device 14 a coupon file with a plurality of merchant coupons, each coupon formatted with fields of a merchant id, a coupon amount, an expiration date, a product identification, and a coupon bar code; means to search and select a product coupon 48; means to display a selected coupon on the device screen 50 that enables the coupon bar code to be scanned by a retail merchant scanner; and means to scroll the coupon file 52; and means to delete individual coupons 54. When the coupon function is activated, it may also automatically delete coupons that have expired. The coupon function 40 may be activated in the device 12 by means of a function key (not shown)

The coupon function 40 has means to link to the coupon system 12 and then is presented categories of coupons with means to select a category and means to provide customer wireless mobile identifier in the form of telephone number, and means for receiving into a mobile device, a personalized coupon file. The coupons in the coupon file are customized to a particular wireless device by the customer wireless mobile number, as illustrated in FIG. 2, by embedding the wireless device id 22A into the coupon bar code 22

The coupon function 40 has means to display on request a coupon number (not shown) that corresponds to the coupon bar code 22, for the coupon number to be entered in an online merchant web page (not shown).

The wireless device 14 is a prior art device that has been adapted with the coupon function 40 features as described above. The technology itself underlying the coupon function 40, as described above is based on programming the device 14 with a coupon function applications with features as described above and is prior art and no specific claim is made for such technology.

With reference to FIG. 3B, the coupon system 12 has a product merchant system interface 60 that provides for managing a merchant account 62; planning and managing a coupon based advertising campaign 64; coupon redemption data feedback 66; a payment system 68 for collecting payment for redeemed coupons from the product merchant, and a web interface 70 that facilitates the product merchant interface.

Also, with reference to FIG. 3B, the coupon system 12 has a customer wireless device interface 72 that provides for, displaying coupon categories 74, receive mobile id and create a custom coupon file 76; and to send the coupon file 78 to the wireless device 14 of the customer.

Also with reference to FIG. 3B, the coupon system 12 has a retail merchant system interface 80 that provides for validating the coupon in real time 82 and periodically sending coupon redeemed funds to the retail merchant system by electronic fund transfer 84.

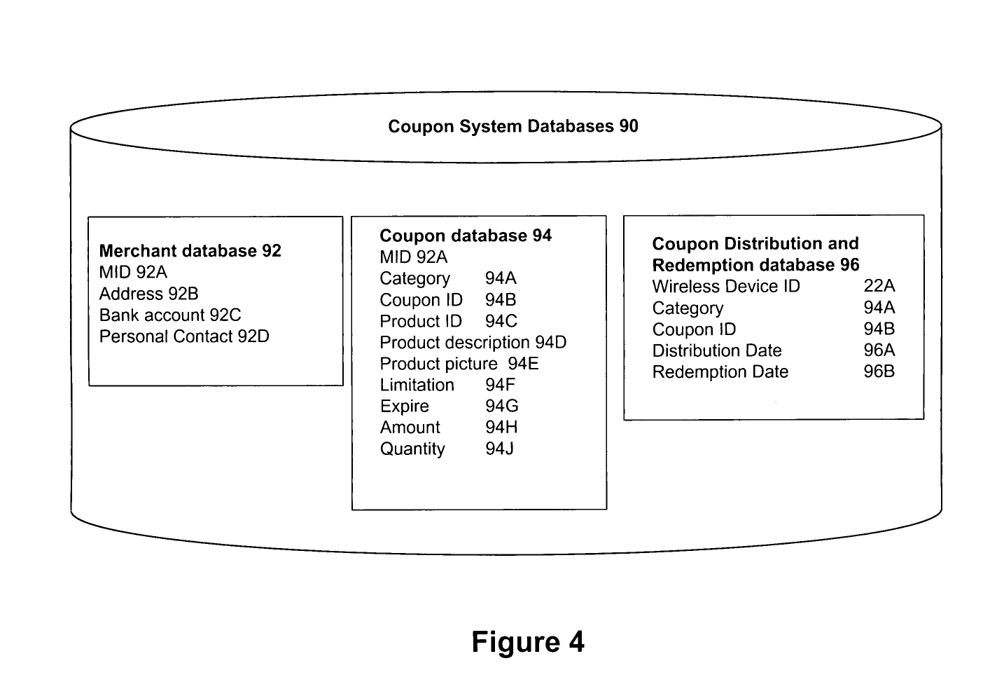

With reference to FIG. 4, the coupon system 12 has databases 90 that support the coupon system functions, as illustrated in FIG. 3B, of product merchant interface 60, customer wireless device interface 72 and retail merchant interface 80.

The product merchant database 92 has fields for merchant id 92A, merchant address 92B, bank account information 92C that may be used for electronic transfer of redeemed coupon funds, and personal contact information 92D.

The coupon database 94 has fields for merchant id 92A, coupon category 94A, coupon id 94C, product id 94C, product information 94D, product picture 94E, coupon limitation 94E, coupon expiration 94G, coupon amount 94H and coupon quantity 94J.

The coupon distribution and redemption database 96 has fields for wireless device id 22A, coupon category 94A, coupon id 94B, distribution date 96A and redemption date 96B.

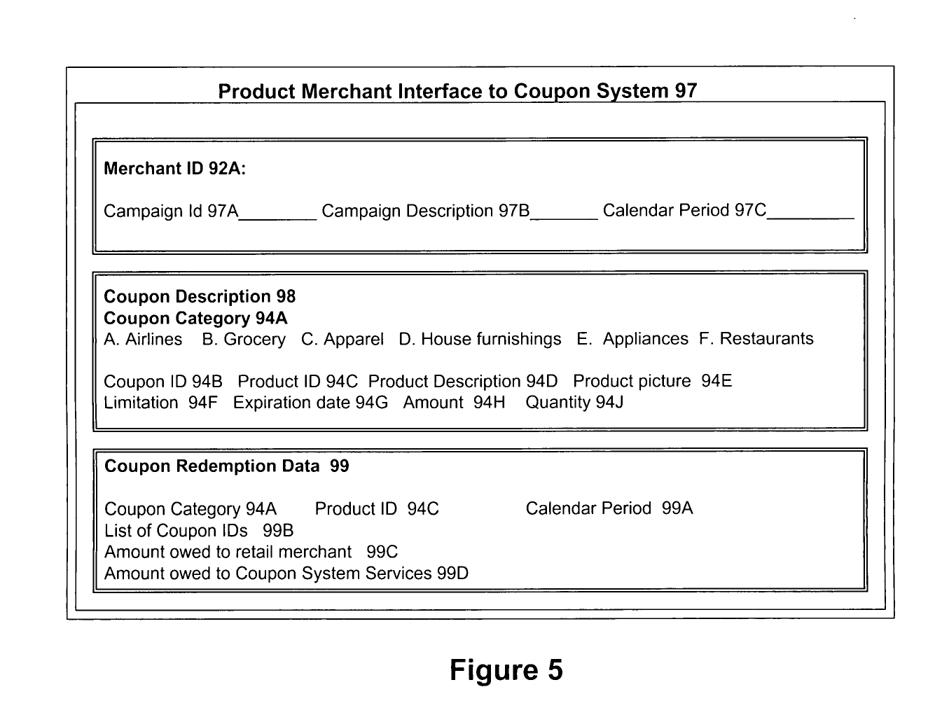

As illustrated in FIG. 5, the product merchant interface 97 to coupon system 12 has a web interface that enables planning a coupon based advertising campaign with fields that support planning such as campaign id 97A, campaign description 97B and calendar period 97C.

The web interface 97 also enables creating and entering in the coupon system 12, the coupon description 98. The coupon description 98 provide for coupon category 94A such as airlines, groceries, apparel, house furnishings, appliances and restaurants among many others.

Each product coupon may be identified by fields of, coupon id 94B, product id 94C, product description 94D, product picture 94E, coupon redemption limitation 94F, coupon expiration date 94G, coupon amount 94H. A coupon quantity 94J is also provided for the product merchant to define the quantity of coupons in this coupon based advertising campaign. The quantity 94J may be entered in numbers that are multiples of 1000.

Also the product merchant interface 97 provides a web interface that enables receiving coupon redemption data 99 by fields of coupon category 94A, product id 94C, calendar period 99A, and list of redeemed coupon ids. 99B. Also provided to the product merchant is the amount owed to the merchants 99C based on redeemed coupons, and also the amount owed to the coupon system for coupon services 99D.

As a source of revenue to the coupon system 12, the coupon system charges a fee to the product merchants for coupon delivery and coupon redemption services. Typically the retail merchant charges a coupon administrative fee to the product merchants for redeeming and processing their paper coupons. In the automated paperless coupon system 12, a coupon administration fee is charged from the product merchants. This fee may be in lieu of the fee charged by the retail merchants. As a simplified illustration, the coupon system 12 may charge a service fee per coupon that is made of two parts, one part is for the coupon delivery to the wireless device and the second part fee may be for those coupons that are actually redeemed by the wireless device owner.

As an added service to the product merchants, a statistical coupon redemption information such as coupon redemption over time and geographical region may also be provided in form of graphs to assist the product merchants to refine their coupon based advertising campaigns.

The coupon system 12 has multiple servers with memory and storage, with interfaces to the Internet, capable of high speed processing and database searches of relational database management system that supports the databases as described above. A web server supports the web interface and other support software supports the interfaces to the wireless device 12, interfaces to the retail merchant 16 for validating coupons in real time and interfaces to the product merchant 28. The coupon system 12 hardware and support software is prior art except the coupon system application that is hosted on the hardware with the help of prior art support software.

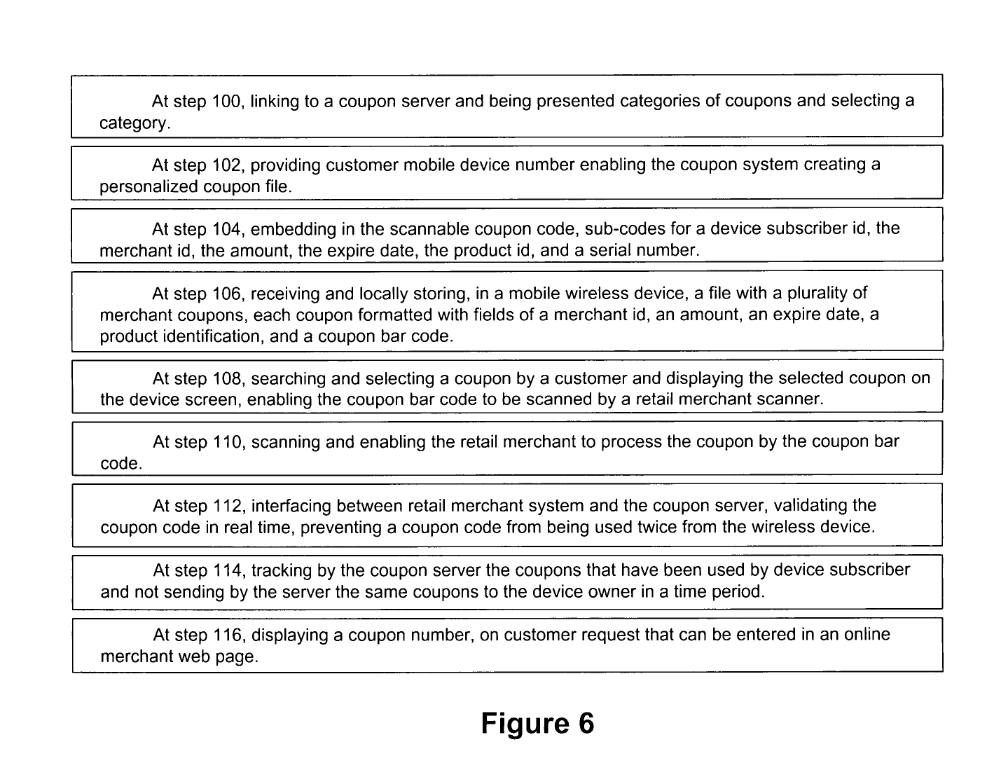

With reference to FIG. 6, a method for delivery for electronic coupons 20 to customer's wireless device 14 and redemption of coupons by retail merchants 16 has the following steps. Not all the steps may be used or used in the order specified:

At step 100, linking to a coupon system by a customer wireless device and being presented categories of coupons and selecting a category.

At step 102, providing customer mobile device number to the coupon system, enabling the coupon system to create a personalized coupon file.

At step 104, embedding in the scannable coupon code, sub-codes for a device subscriber id, the merchant id, the amount, the expiration date, the product id, and a serial number.

At step 106, receiving and locally storing, in the mobile wireless device, a file with a plurality of merchant coupons, each coupon formatted with fields of a merchant id, an amount, an expire date, a product identification, and a coupon bar code.

At step 108, searching and selecting a coupon by a customer and displaying the selected coupon on the device screen, enabling the coupon bar code to be scanned by a retail merchant scanner.

At step 110, scanning and enabling the retail merchant to process the coupon by the coupon bar code.

At step 112, interfacing between retail merchant system and the coupon server, validating the coupon code in real time, preventing a coupon code from being used twice from the wireless device.

At step 114, tracking by the coupon server the coupons that have been used by device subscriber and not sending by the server the same coupons to the device owner in a time period.

At step 116, displaying a coupon number that can be entered into an online-merchant's web page.

In summary, the preferred embodiment of the electronic coupon delivery and redemption system 10 provides for delivery of product coupons 20 of the product merchants 28 to customers wireless mobile devices 14. The preferred embodiment provides for coupon redemptions by retail merchants 16 by scanning the coupon bar code 22 from the wireless device 14 screen and to validate the coupon for one time use by interfacing of the retail merchant system 16 with the coupon server 12. The preferred embodiment provides for the product merchant to receive coupon redemption data from the coupon server 12 and to facilitate payment to the retail merchant aggregate funds for the redeemed funds via the coupon system 12. Thus, the preferred embodiment of the electronic coupon system 10 provides an efficient, versatile, and convenient paperless coupon system.

While the particular invention, as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

What is claimed is:

1. A system for delivery of coupons of product merchants to customers and redemption by retail merchants, comprising:
a. a product merchant interface to a coupon system for creating an account and entering product coupons data in the coupon system; and
b. the coupon system sends customized coupon files to wireless mobile receivers of customer, on customer request, when the mobile device is identified to the coupon system by a wireless mobile device identifier.

2. The system as in claim 1, further comprising:
a. the wireless device receives and locally stores in the device a coupon file with a plurality of merchant coupons, each coupon formatted with fields of a product merchant id, a coupon amount, an expire date, a product identification, and a coupon bar code;
b. the device enables the customer to search and select a product coupon and display the selected coupon on the device screen, enabling the coupon bar code to be scanned by a retail merchant scanner.

3. The system as in claim 2, further comprising:
the coupon bar code embeds, sub-codes for a wireless device identifier, the product merchant id, the coupon amount, the coupon expire date, the product identification, and a serial number, enabling the retail merchant to process the coupon by the coupon bar code.

4. The system as in claim 3, further comprising:
the retail merchant system interfaces with the coupon system in real time, validating the coupon code and preventing a coupon code from being used twice from the wireless device.

5. The system as in claim 4, further comprising:
the coupon system tracks the coupons that have been redeemed and provides an accounting to the product merchant via the product merchant interface to the coupon system.

6. The system as in claim 4, further comprising:
the coupon system tracks the coupons that have been used by the wireless device identifier and prevents the coupon system from sending the same coupons to the same wireless device in a time period.

7. The system as in claim 1, further comprising:
the product merchant interface comprising a web interface that enables (i) planning a coupon based advertising campaign, (ii) creating and entering in the coupon server, product coupons, each coupon identified by fields of product id, coupon amount, redemption limitations, and coupon expiration.

8. The system as in claim 1, further comprising:
the product merchant interface comprising, a web interface that enables receiving coupon redemption data and paying for the redeemed coupons to the retail merchant.

9. A coupon function in a mobile wireless device, comprising:
a. a means to receive and locally store in the mobile wireless device, a file with a plurality of merchant coupons, each coupon formatted with fields of, a merchant id, a coupon amount, an expire date, a product identification, and a coupon bar code; and
b. a means to search and select a product coupon and display a selected coupon on the device screen that enables the coupon bar code to be scanned by a retail merchant scanner.

10. The function as in claim 9, further comprising:
a. means to link to a coupon system and being presented categories of coupons with means to select a category;
b. means to provide customer wireless mobile number, and means for receiving into the mobile device, a personalized coupon file.

11. The function as in claim 9, further comprising:
a. the scannable coupon code embeds sub-codes for a wireless device identifier, a merchant identifier, an amount, an expire date, a product identification, and a serial number;
b. the coupon code enables the retail merchant to process the coupon by the coupon code.

12. The function as in claim 11, further comprising:
an interface between the retail merchant system and the coupon system that in real time validates the coupon code and prevents a coupon code from being used again from the same wireless device.

13. The function as in claim 12, further comprising:
the coupon system tracks the coupons that have been used by wireless device and the system preventing sending the same coupons to the same wireless device in a time period.

14. The function as in claim 9, further comprising:
a means to display on request a coupon number that corresponds to the coupon bar code, for the coupon number to be entered in an online merchant web page.

15. A method for delivery of coupons to customers and redemption by retail merchants, comprising the steps of:
a. receiving and locally storing, in a mobile wireless device, a file with a plurality of merchant coupons, each coupon formatted with fields of a merchant identifier, an amount, an expiration date, a product identification, and a coupon bar code;
b. searching and selecting a coupon by a customer and displaying the selected coupon on the device screen, enabling the coupon bar code to be scanned by a retail merchant scanner.

16. The method as in claim 15, further comprising the steps of:
a. linking to a coupon server and being presented categories of coupons and selecting a category;
b. providing customer wireless device number and receiving into the wireless device, a personalized coupon file.

17. The method as in claim 15, further comprising the steps of:
a. embedding in the scannable coupon code, sub-codes for a wireless device identifier, the merchant identifier, the amount, the expiration date, the product identification, and a serial number;
b. scanning and enabling the retail merchant to process the coupon by the coupon bar code.

18. The method as in claim 17, further comprising the steps of:
Interfacing, by the retail merchant system, with the coupon system, validating the coupon code in real time and preventing a coupon code from being used twice from the same wireless device.

19. The method as in claim 17, further comprising the steps of:
tracking by the coupon system the coupons that have been used by a wireless device and preventing sending the same coupons to the wireless device in a time period.

20. The method as in claim 17, further comprising the steps of:
displaying a coupon number on request, the coupon number corresponding to the coupon bar code, and entering the coupon number in an online merchant web page.
